(19) United States
(12) Patent Application Publication
(10) Pub. No.: US 2023/0386373 A1
(43) Pub. Date: Nov. 30, 2023

(54) DISPLAY DEVICE WITH DARK RING ILLUMINATION OF LENSLET ARRAYS FOR VR AND AR

(71) Applicant: Tesseland LLC, Glendale, CA (US)

(72) Inventors: Pablo Benítez, Madrid (ES); Julio C. Chaves, Coimbra (PT); Juan Carlos Miñano, Madrid (ES)

(21) Appl. No.: 18/248,087

(22) PCT Filed: Oct. 12, 2021
(86) PCT No.: PCT/IB2021/059302

§ 371 Date: Apr. 6, 2023

Related U.S. Application Data
(60) Provisional application No. 63/090,795, filed on Oct. 13, 2020.

(51) Int. Cl. G09G 3/00

(52) U.S. Cl. CPC G09G 3/002; G09G 2352/00

(57) ABSTRACT

A display device including a display panel to generate a real image, and an optical system. The optical system includes a plurality of lenslets, each having one cluster of object pixels, where the assignation of object pixels to clusters may change periodically in time intervals. The cluster emits light towards its corresponding lenslet and the emission is such that no light is sent to neighbor lenslets to avoid cross-talk between channels. Each channel projects a partial virtual image into the eye. The combination of all partial virtual images creates a virtual image. In a preferred embodiment, the partial images of neighbor channels are interlaced, which allows for a higher resolution. Additionally, each channel may be devoted to a single color, avoiding color filters and allowing for a higher efficiency.

### CROSS REFERENCE TO RELATED APPLICATIONS

This application claims benefit of commonly invented and assigned U.S. Provisional Patent Application No. 63/090,795, titled “Lenslet Based Preform Optics”, filed on Oct. 13, 2020. This application is incorporated herein by reference in their entirety. This application contains subject matter related to commonly assigned WO/2021/113825 (PCT/US2020/063629) with inventors in common, for “Lenslet based ultra-high resolution optics for virtual and mixed reality,” referred to herein as “PCT11”; WO 2015/077718, published 28 May 2015, which is PCT/US 2014/067149 for “Immersive compact display glasses,” referred to below as “PCT1”; WO 2016/118640, published 28 Jul. 2016, which is PCT/US 2016/014151 for “Visual display with time multiplexing,” referred to below as “PCT2”; WO/2018/237263, published 27 Dec. 2018, which is PCT/US2018/038992 for “Visual display with time multiplexing for stereoscopic view,” referred to below as “PCT8”; which are incorporated herein by reference in their entirety.

### FIELD OF THE INVENTION

The application relates to a display device including a display to generate a real image and an optical system and, more particularly, to an improved optical system with a plurality of lenslets each producing a ray pencil from each object pixel of a cluster.

### BACKGROUND

### 1. References Cited

WO 2015/077718, published 28 May 2015, which is PCT/US 2014/067149 for “Immersive compact display glasses,” referred to below as “PCT1”.
WO 2016/118640, published 28 Jul. 2016, which is PCT/US 2016/014151 for “Visual display with time multiplexing,” referred to below as “PCT2”.
WO/2018/237263, published 27 Dec. 2018, which is PCT/US2018/038992 for “Visual display with time multiplexing for stereoscopic view,” referred to below as “PCT8”.
WO/2021/113825, published 10 Jun. 2021, which is PCT/US2020/063629 for “Lenslet based ultra-high resolution optics for virtual and mixed reality,” referred to below as “PCT11”.
Douglas Lanman, David Luebke, Near-Eye Light Field Displays, ACM SIGGRAPH 2013 Emerging Technologies, July 2013.

### 2. Definitions

| | |
|---|---|
| Accommodation | Small region in the image space where a single human eye accommodates |
| pixel or a-pixel | when it gazes that region and its foveal region is illuminated (completely or |
| | partially) by a set of pencils carrying the same information (same |
| | luminance and color). This set of pencils, which may consist of one or |
| | more pencils, is said to form the a-pixel. That luminance and color become |
| | a property of the a-pixel at a given instant. The pencils are such that their |
| | principal rays meet near the a-pixel, which is also close or coincident with |
| | the location of the waist of the union of those pencils. Nevertheless, this |
| | waist is not necessarily close to the individual waists of the different |
| | pencils forming the a-pixel. A given pencil is part of no more than one a- |
| | pixel during a given time interval but it may be part of different a-pixels at |
| | different instants. If a set of pencils is forming always the same a-pixel, the |
| | a-pixel is said to be static. In this case, all the pencils of the a-pixel carry |
| | always the same luminance and color. Otherwise, the a-pixel is said to be |
| | dynamic. The eye perceives the a-pixel as an emitting region when its |
| | luminance is high enough and it is located at sufficient distance from the |
| | eye. |
| Aperture stop | There may be one aperture stop per channel. The aperture stop position is |
| | in general closer to the eye than the corresponding lenslet. The purpose of |
| | the aperture stop is avoiding crosstalk between channels. The aperture stop |
| | may contain color and/or polarization filters. The aperture stops of the |
| | different channels may be configured on a flat array as a mask on the |
| | lenslets aperture plane where it may also help to reduce stray light. |
| Accommodation | In some optical systems, accommodation pixels can be grouped by its |
| surface | proximity to certain surfaces. These surfaces are called accommodation |
| | surfaces. Sometimes they are approximated by spheres or even by planes, |
| | taking the names accommodation sphere or accommodation plane. |
| Backlight emitter | A backlight emitter, or emitter for short, is the entrance of light to a |
| or light emitter or | microlenslet. It may be, for instance, an LCD shutter opening or closing a |
| emitter | light flow, which is generated elsewhere (for example generated by some |
| | Edge LEDs of an Edge-lit LED backlight), or an LED that switches ON |
| | and OFF to control the light flow. The emitter may also be in an |
| | intermediate state between ON and OFF to control the amount of light |
| | emitted. The purpose of this control may be, for instance, the application of |
| | local dimming techniques for energy saving, like in a back-lit LED |
| | backlight. The light controlled by the emitter may be R, G, B, white or any |
| | color combination. Since the emitters are imaged on the lenslets exit |
| | apertures, their position, size and shape must be according to position, size |
| | and shapes of the lenslets' output pupils. |
| | The assignation of an emitter to a microlenslet is dynamic and depends on |
| | the eye pupil position. |
| | The emitters are placed in a surface called emitters' surface. |
| Centered gazing | Field associated to the ray trajectory passing through the lenslet exit |
| field of a lenslet | aperture center and whose straight prolongation passes through the center |
| | of the eyeball sphere. |
| Channel | Backlight emitters, micro-lenslets, o-pixel cluster and all the optics through |
| | which the cluster image is sent to the eye. This optics is in general a lenslet |
| | made up of minilenses but can also comprise conforming lenses. A |
| | conforming lens cannot be assigned totally or partially to a particular |
| | channel unlike lenslets, which have a one-to-one correspondence with |
| | channels. A channel may also include aperture stops. Any channel has a |
| | single lenslet and single cluster. Unlike the lenslet, the o-pixels forming the |
| | cluster may change with time. The lenslet to channel correspondence only |
| | changes with time in the time multiplexing configurations disclosed in |
| | PCT2. In this case the change is periodic. |
| | The image produced by the rays of a channel on the viewer's retina is a |
| | continuous mapping of the image on the cluster. Sometimes channel refers |
| | to the set of rays emitted by a cluster and reaching the pupil range. |
| Channel-confined | In this type of illumination, the light from a channel's clusters only lits its |
| illumination | own cluster and not any other one. This illumination avoids any crosstalk |
| | between channels. In general, a satisfactory channel-confined illumination |
| | is achieved when no light is sent to the neighboring channels, not paying |
| | attention to the light sent to more distant channels. The neighboring |
| | channels may include the ring of the immediate neighboring channels, i.e., |
| | those that share a border with the channel in question, the second ring of |
| | immediate neighboring of the first ring and some other rings if necessary. |
| Cluster | Set of o-pixels assigned to a single channel and that are imaged by it. The |
| | assignation of object pixels to clusters is dynamic, i.e., it may change with |
| | time, and typically the changes occur periodically in time intervals, |
| | preferably a frame period. The set of o-pixels forming a cluster is |
| | subdivided in disjoint subsets called microclusters plus some few dark o- |
| | pixels in the border regions of the clusters. |
| Conforming lens | Lens intercepting the path of every ray illuminating the pupil range from |
| | the panel. Unlike a lenslet array, a conforming lens cannot be divided in |
| | disjoint portions such that each one of them is working solely for a single |
| | channel. A conforming lens can be placed between the eye and the rest of |
| | the optical system or between lenslet arrays or even between the panel |
| | display and the rest of the optical system. A conforming lens may have at |
| | least one surface with slope discontinuities to either reduce its thickness as |
| | a Fresnel lens, or to habilitate the use of two or more displays per eye. |
| | Examples of conforming lenses may also include trains of lenses or |
| | “pancake” optical configurations described by La Russa U.S. Pat. No. 3,443,858. In |
| | particular, the train may include two or three lenses of equal or different |
| | materials, at least one with positive power and at least another with |
| | negative power, combination providing chromatic aberration correction |
| | and/or other geometrical aberration corrections, as field curvature. |
| | Alternatively, two materials can be used, one with higher dispersion than |
| | the other. Lens surfaces may therefore be convex or concave, or even how |
| | inflection points so they are peanut type in form. This is why a conforming |
| | lens is sometimes called “peanut” lens |
| Dark corridor or | Set of o-pixels turned off along the cluster's peripheries. This guard further |
| guard | reduces optical crosstalk while guaranteeing a certain tolerance for the |
| | optics positioning. This o-pixel set changes with time. Since the visible |
| | region of the cluster excludes that dark corridor, this visible region is more |
| | smoothly shifted on the panel as the eye pupil moves, not linked to the |
| | microlenslet pitch but to the o-pixel pitch. |
| Eye pupil | Image of the interior iris edge through the eye cornea seen from the exterior |
| | of the eye. In visual optics, it is referred to as the input pupil of the optical |
| | system of the eye. Its boundary is typically a circle from 3 to 7 mm |
| | diameter depending on the illumination level. |
| Eye sphere | Sphere centered at the approximate center of the eye rotations and with |
| | radius rₑ the average distance of the eye pupil to that center (typically 10-13 |
| | mm). |
| Field of View or | Simply connected angular region containing the solid angle subtended by |
| FOV | union of all pencil waists from the eye center. Its size use to be described |
| | by its horizontal and its vertical full angles. It may be different for left and |
| | right eye's. |
| Fixation point | Point of the scene that is imaged by the eye at center of the fovea, which is |
| | the highest resolution region of the retina. Rays hitting the fovea typically |
| | imping on the eye ball forming an angle smaller than 2.5 deg with respect |
| | to the eye lens optical axis. |
| Foveal ray | Ray reaching the eye ball such that its straight prolongation virtually |
| | intersects the foveal reference sphere |
| Foveal reference | A sphere concentric with the eye sphere center with radius between 2 and 4 |
| sphere | mm. This sphere is virtually crossed by the straight prolongation of the |
| | foveal rays, which reach the fovea for at least one pupil position belonging |
| | to the pupil range. |
| Full color pixel | RGB or RGBW or any other set of different color neighbor o-pixels which |
| | is commonly called “pixel” in the literature |
| Gaze vector γ | Unit vector γ of the direction linking the center of the eye pupil and the |
| | fixation point. |
| Gazeable region | Angular region of the Field of View containing the projections from the |
| of the FOV | eye sphere center of all the a-pixels that can be gazed. |
| Gazing line | Straight line supporting the gaze vector. |
| Human angular | Minimum angle subtended by two point sources that are distinguishable by |
| resolution | an average perfect-vision human eye. The angular resolution is a function of |
| | the peripheral angle and of the illumination level. |
| Inner lit pencil | Pencil illuminating properly the pupil, i.e., the pencil belongs to a cluster |
| | whose associated optical channel is the one through which the pencil |
| | illuminates the pupil. |
| Kappa angle | The kappa angle is the angle formed between a human eye visual axis (also |
| | called line of sight or foveal-fixation axis) and its optical axis (also called |
| | pupillary axis). The optical axis is composed of an imaginary line |
| | perpendicular to the cornea that intersects the center of the entrance pupil. In |
| | comparison, the visual axis is an imaginary line that connects the object in |
| | space, the center of the entrance and exit pupil, and the center of the fovea. |
| | The value of the kappa angle varies greatly (1.5 to 5.8 deg) not only between |
| | different people but even between the two eyes of the same person (Oman J |
| | Ophthalmol. 2013 September-December; 6(3): 151-158.doi: 10.4103/0974- |
| | 620X.122268) |
| Lenslet | Each one of the individual optical imaging systems (such as a mirror or a |
| | lens or a mixed set of lenses and mirrors for instance) of the optics array, |
| | which collects light from the panel display and projects it to the eye sphere, |
| | sometimes directly to eye sphere and sometimes with the aid of an |
| | additional lens, called “conforming lens”, which is common for all the |
| | lenslets in the array. The lenslets are designed to lit pencils with the light of |
| | its corresponding o-pixels. There is one lenslet per channel and one channel |
| | per lenslet. There is also one cluster per channel (the cluster gathers all the |
| | o-pixels corresponding to a single channel) but, unlike the lenslets, the |
| | definition of the opixels belonging to a cluster is dynamic. The mapping |
| | between the o-pixel plane and the waist surface of the corresponding |
| | pencils induced by a single lenslet is continuous. Each lenslet may be |
| | formed by one or more optical surfaces, not necessarily refractive. The |
| | different parts of a lenslet are generically called minilenses. The minilenses |
| | of a single lenslet process the light sequentially or “in series”, i.e., one |
| | minilens after another from the digital display to the eye, unlike the |
| | minilenses of a single minilens array that process the light in “parallel”. |
| Local dimming | The average brightness emitted by an o-pixel in a transmissive panel is the |
| | product of the transmission (power transmitted over incoming power) of |
| | this pixel times the brightness of the emitter's light sent by the |
| | corresponding microlenslet. Since the non-transmitted light is in general |
| | absorbed, then, with the aim to save light power, the brightness of the |
| | brighter o-pixel in the microcluster may be achieved by setting the |
| | maximum possible transmission of the o-pixel while dimming the emitter |
| | to get the desired o-pixel brightness. The brightness of the remaining |
| | microcluster's o-pixels, which receive light with the same brightness, are |
| | achieved by controlling their transmissions. |
| Microcluster | Subset of o-pixels of a cluster that are lit by the same microlenslet. An o- |
| | pixel is assigned to the microlenslet whose exit aperture is closer. Since the |
| | plane of o-pixels and that of the microlenslet exit apertures are very close |
| | (but not coincident) this assignation is very obvious excepting for the o- |
| | pixels near the microlenslet borders. The o-pixels to microlenslet |
| | assignation is essentially static, i.e., it does not change with time, although |
| | there may be small changes, particularly when the microlens and the object |
| | pixels' patterns are not coincident. |
| | Each microlenslet is dynamically assigned to a single channel. |
| | Consequently, each microcluster results dynamically assigned to a single |
| | channel. |
| Microlenslet or | Each one of the individual optical systems (typically a microlens), which |
| microlens | collects light from a backlight emitter and projects it to the panel. In the |
| | best configuration, the microlenslet forms the image of the emitter at the |
| | lenslet exit aperture, like in Köhler illumination, and must guarantee that |
| | no light is sent through any of the immediate neighborgh channels. For this |
| | purpose, the backlight emitter may consist of an emitting region, which is |
| | more properly called the emitter, surrounded by dark ring regions, which |
| | are the regions whose light emission would fall in the immediate neighbor |
| | channels, giving rise to the unwanted optical crosstalk. |
| | In order to increase the light transport efficiency from emitter to |
| | microcluster and also to increase the illumination fill factor of the emitter |
| | image on the minilens aperture plane, a nonimaging element associated to |
| | each emitter may be used. |
| Microlenslet | Microlenslets are arranged in an array such that their entry and exit |
| array | apertures are coplanars to match with the panel plane and with the |
| | backlight emitters' plane. |
| Neighborgh | During normal operation of a backlight emitter, if a reference emitter is |
| emitter rings | open, then its close neighbors are closed to avoid crosstalk. The position of |
| | the eye pupil determines which emitters are open (active) and which ones |
| | must be closed (inactive). In general, the active emitters emit light although |
| | when local dimming is applied, then the image content of the microcluster |
| | associated to the microlenslet of an active emitter determines how may |
| | light is sent to the microcluster. The neighborgh emitters are clasified |
| | according the distance to the reference emitter. In this clasification, there is |
| | a first set formed by the closests neighborgh emitters, the adjacent emitters, |
| | which in general form a ring around the reference emitter, excepting when |
| | the reference emitter is in a border and so without neighborgh emitters |
| | completely surrounding it. In the same way we can define a second ring of |
| | emitters as the adjacent emitters to the first ring (excluding the reference |
| | emitter). |
| | Typically more than one ring is closed when an emitter is active. |
| Nonimaging | A collimator collecting the light from an emitter and sending it to the |
| collimator for | microlenslets array. The main purposes of this element is improving the fill |
| emitters | factor of the spot of light of the emitter reaching the lenslet aperture plane |
| | and improving the light collection efficiency. |
| Object pixel or | Unit of information of the panel display. The object pixel is a small |
| o-pixel | emitting surface region (diameter between 3 and 6 microns typically) of the |
| | panel. All the points of an o-pixel surface emit (really or virtually) with the |
| | same illuminance and color, with a constant angular emission pattern and |
| | with similar polarization state. Illuminance and color are detectable by the |
| | eye when the light reaches the retina. Emission pattern, polarization state |
| | and sometimes color are characteristics that may determine the path of the |
| | light through the optics, conditioning, for instance, the channel through |
| | which the light is going to flow. All the rays emitted by an o-pixel and |
| | reaching a human eye have, in general, the same or similar luminance and |
| | color. The o-pixel is often called subpixel in the literature where the name |
| | pixel is reserved to the combination of several colors (typically RGB) |
| | neighbors' subpixels. |
| Optical crosstalk | Undesirable situation in which more than one pencil illuminated by the |
| | same o-pixel reaches the eye's retina. |
| Outer region of | Angular region of the virtual screen complementary to the gazeable region |
| the FOV | of the FOV. |
| overfilling | Eye illumination strategy such that the light sent from the digital display to |
| | the eye pupil by the optics fills the pupil completely. |
| Panel (or digital | Opto-electronic component that modulates temporally and spatially the |
| display) | light emitted by a surface. In the present invention, the light is not |
| | generated at the panel display, but only modulated by it, like in an LCOS or |
| | an LCD panel. This invention is not restricted to flat displays. Curved |
| | displays, in particular cylindrical ones, are of interest to increase the FOV |
| | and reduce optical aberrations. |
| Pencil | Set of straight lines that contain segments coincident with ray trajectories |
| | illuminating the eye, such that these rays carry the same information at any |
| | instant. The same information means the same (or similar) luminance, color |
| | and any other variable that modulates the light and can be detected by the |
| | human eye. In general, the color of the rays of the pencil is constant with |
| | time while the luminance changes with time. This luminance and color are |
| | a property of the pencil. The pencil must intersect the pupil range to be |
| | viewable at some of the allowable positions of the pupil. When the light of |
| | a pencil is the only one entering the eye's pupil, the eye accommodates at a |
| | point near the location of the pencil's waist if it is being gazed and if the |
| | waist is far enough from the eye. The rays of a pencil are representable, in |
| | general, by a simply connected region of the phase space. The set of |
| | straight lines forming the pencil usually has a small angular dispersion and |
| | a small spatial dispersion at its waist. A straight line determined by a point |
| | of the central region of the pencil's phase space representation at the waist |
| | is usually chosen as representative of the pencil. This straight line is called |
| | central ray of the pencil. The waist of a pencil may be substantially smaller |
| | than 1 mm² and its maximum angular divergence may be below ±10 mrad, |
| | a combination which may be close to the diffraction limit. The pencils |
| | intercept the eye sphere inside the pupil range in a well-designed |
| | embodiment. The light of single o-pixel may light up one or more pencils |
| | each one of them corresponding to different channels. These pencils are |
| | called the associated pencils of the o-pixel. In a well designed embodiment |
| | the associated pencils of an o-pixel that pass through the pupil and reach |
| | the eye's retina simultaneously must have the same or similar waist, |
| | otherwise there is undesirable crosstalk between lenslets. When at least one |
| | of these associated pencils reaches the retina the o-pixel is said to be |
| | viewable. One channel plus one o-pixel may determine more than a single |
| | pencil when the lenslet optics is sensitive to polarization state, to color or to |
| | any other variable that the o-pixel may change. The o-pixel to lenslet |
| | cluster assignation is dynamic and depends on the eye pupil position. |
| Pencil interlacing | Pencil interlacing happens when pencils of neighbor lenslets have their |
| | corresponding waists interleaved in the waist surface. Pencil interlacing |
| | strategy allows increasing the density of pencil waists without increasing |
| | the lenslets focal length nor the o-pixel density. When the lenslets apertures |
| | are small enough, these interlaced pencils reach the retina simultaneously |
| | through the eye's pupil, thus effectively increasing the perceived resolution |
| | (i.e., increasing the pixels per degree). |
| Pencil print | Region of the eye globe enclosing the intersection of the straight lines of a |
| | pencil with the globe. The globe is sometimes approximated by a plane. |
| Peripheral angle | Angle β formed by a certain direction with unit vector θ and the gaze unit |
| | vector γ, i.e., β = arccos(θ · γ) |
| Peripheral pencil | A peripheral pencil is a pencil where none of its rays is foveal. |
| Pupil range | Region of an imaginary sphere comprising all expected eye pupil positions. |
| | Said sphere is fixed to the user's skull and approximates the eyeball sphere. |
| | Its diameter is between 8 and 12 mm. In practice, the maximum pupil |
| | range is an ellipse with angular horizontal semi-axis of 60 degs and vertical |
| | semi-axis of 45 degs relative to the front direction, but a practical pupil |
| | range for design can be a 40 to 60 deg full angle cone, which is the most |
| | likely region to find the pupil. This region is known as the static pupil |
| | range. When the system has eye-tracking it is interesting to define also a |
| | dynamic pupil range, which comprises the expected pupil positions for a |
| | given time slot. This region in general comprises a single pupil position. |
| Scene | Simply connected region of the space containing, at least, every a-pixel, v- |
| | pixel and pencil waist. |
| underfilling | Eye illumination strategy such that the light sent from the digital display to |
| | the eye pupil by the optics does not fill the pupil completely. Maxwellian |
| | pupil illumination is a case of underfilling. |
| Vergence pixel or | Small region in the image space where the two human eye converge when |
| v-pixel | each one of them is illuminated on its foveal region by pencils forming a |
| | corresponding a-pixel, one for each eye, both a-pixels carrying the same |
| | information (same luminance and color). This pair of a-pixels is said to |
| | form the v-pixel. The v-pixel is located near the intersection of the two |
| | gazing lines (one per eye) when the v-pixel is gazed. A given a-pixel is part |
| | of no more than one v-pixel at a given time interval but it may be part of |
| | different v-pixels at different instants. The human vision perceives the v- |
| | pixel as a single emitting region when its luminance is high enough and |
| | when it is located far enough from the eye. The location of the v-pixel does |
| | not coincide in general with the location of the two a-pixels forming it, but |
| | it should be as close to them as possible to minimize the vergence- |
| | accommodation conflict (VAC). |
| Viewable o-pixel | viewable object pixel is an object pixel for which at least one of its |
| | associated pencils intersects the eye pupil. |
| Waist | The waist of a set of straight lines, for instance a pencil, is the minimum |
| | area region of a plane intersecting all the straight lines such that when all |
| | those straight lines are rays carrying the same radiance, then the waist |
| | encloses all the points of that plane with irradiance greater than 50% of the |
| | maximum irradiance on that plane. This flat region is in general normal to |
| | the pencil's central ray. |
| Waist plane or | In some optical systems the waists of some or all of the pencils can be |
| waist surface | grouped by its proximity to certain surfaces. These surfaces are called waist |
| | surfaces. Sometimes they are approximated by planes. These planes use to |
| | be normal to the frontward direction |

### 3. State of the Art

Head mounted display (HMD) technology is a rapidly developing area. An ideal head mounted display combines a high resolution, a large field of view, a low and well-distributed weight, and a structure with small dimensions.

The embodiments disclosed herein refer to lenslet array based optics. This type of optics have been used in HMD technologies in the frame of Light Field Displays (LFD) to provide a solution to the vergence-accommodation conflict (VAC) appearing in most present HMDs. As yet LFD may solve this conflict at the expense of having a low resolution. State of the art of a LFD of this type was described by Douglas Lanman, David Luebke, “Near-Eye Light Field Displays” ACM SIGGRAPH 2013 Emerging Technologies, July 2013, “Lanman 2013”.

### SUMMARY

Designing a optic for virtual reality that is compact, produces a wide field of view and a high resolution virtual image is a challenging task. Refractive single channel optics are commonly used, but the difficulty in designing them arises from the fact that they must handle a significant etendue. In order to control all this light one needs a large number of degrees of freedom which typically means using many optical surfaces, making the resulting optic complex and bulky. One possible alternative is to use folding optics, such as the pancake design. However, these tend to have very low efficiencies, which is a significant drawback in devices meant to light and to run on batteries.

An alternative to these technologies is to use multiple channel optics. Now, each channel handles a much smaller etendue and is therefore easier to design, resulting in simpler, smaller and more efficient optical configurations. Multiple channel configurations, however, tend to have duplicated information on the display, which lowers the resolution that may be achieved.

This invention describes several strategies to overcome the limitations to multi-channel configurations, increasing resolution while reducing the size of the optics and increasing energy efficiency. Traditional multi-channel configurations (such a lens arrays combined with a display) create an eye box within which the eye may move and still be presented with a visible virtual image. These, however, are low focal, low resolution configurations. One option to increase resolution is to increase the focal length of the lenses in the array. This reduces the eye box size and leads to the need to use eye pupil tracking. Increasing the focal length also increases the thickness of the device (due to the longer focal length). This strategy increases resolution at the cost of eye tracking and an increased device thickness. These configurations maintain duplicate information in the display, where the same information is shown through different channels in order to compose the virtual image.

One step further eliminates the duplicate information in the display. As is disclosed in PCT11 this strategy permits an increased focal length, which in turn results in an increased resolution. However, a longer focal length also leads to a larger device which may be undesirable. In an alternative configuration, the lenses in the array are split into families and the focal length reduced, reducing device size. Each family now generates a lower resolution virtual image, but said virtual images generated by the different families are interlaced to recover a high resolution. These configurations combine the compactness of short focal devices with high image resolution. However, these configurations don't make a full use of the panel because some panel pixels (also called object pixels) need to be turned off to avoid crosstalk between channels and consequently cannot be used to send images to the eye. This crosstalk occurs because each channel is designed to create on the eye retina a partial virtual image from the light coming from a particular set of object pixels (called cluster), and so, the light coming from pixels not belonging to its cluster and processed by the channel may create unwanted overlapped images. This is particularly dangerous for the pixels that are physically close to the cluster. Light from pixels far from the cluster may illuminate the channel, but the channel redirects it far from the eye pupil so that light does not get into the eye and does not creates crosstalk, in general.

A step further to make full use of the panel is disclosed herein. This step consist of confining the emission of the panel pixels so the light emanating from them does not illuminate channels close to the right one. This eliminates the need of turning off some object pixels, allowing for a full use of the panel. This strategy not only improves the effective use of all panel pixels but also reduces the power consumed by reducing the light emitted outside the eye pupil. Additionally, as disclosed herein, this strategy allows also color images without the use of absorbing filters, improving energy efficiency and cost a bit further. Optionally, color sequential can be used (which leads to improvements in virtual image resolution) if the panel switching speed.

A display device is disclosed comprising a panel, operable to generate a real image comprising a plurality of object pixels; and an optical system, comprising a plurality of lenslets; the panel and the optical system both arranged in a plurality of channels, each channel comprising a lenslet and a cluster of object pixels;
wherein the assignation of object pixels to clusters may change in time intervals;
wherein each object pixel of a cluster projects a corresponding ray pencil from the channel lenslet towards an imaginary sphere at an eye position; said sphere being an approximation of the eyeball sphere and being in a fixed location relative to a user's skull;
wherein said ray pencils of each channel are configured to generate a partial virtual image from a real image of its corresponding cluster, and wherein the partial virtual images of the channels combine to form a virtual image to be visualized through a pupil of an eye during use; and
wherein the average illuminance produced by each cluster on the output pupil of the lenslet associated to this cluster is at least 10 times greater than the average illuminance generated by this cluster on the output pupil of at least one of any other lenslet.

Preferably the average illuminance produced by at least one cluster on the output pupil of the lenslet associated to this cluster is at least 10 times greater than the average illuminance generated by this cluster on the output pupil of a set of lenslets surrounding the lenslet associated to that cluster.

Preferably said set of lenslets include the lenslets adjacent to the lenslet associated to the cluster.

Optionally at least two of the lenslets cannot be made to coincide by a simple translation rigid motion.

Adjacent lenslets preferably project light of different primary colors, the different colors may be produced by color filters.

At least one lenslet may have a pancake optical configuration.

Waists of the pencils of adjacent lenslets are may be at a waist surface.

Foveal rays may be a subset of rays emanating from the lenslets during use that reach the eye and whose straight prolongation is away from the imaginary sphere center a distance smaller than a value between 2 and 4 mm; and the image quality of the virtual image formed by the foveal rays is greater than the image quality of the virtual image formed by non-foveal rays emanating from the lenslets during use.

Each lenslet may produce a ray pencil from each object pixel of its corresponding cluster, said pencils having corresponding waists laying close to a waist surface.

Preferably the ray pencils are activated to make the accommodation pixels lay close to a waist surface.

A backlight may be included to illuminate the panel.

A backlight may be included to illuminate the panel, wherein the backlight comprises a plurality of microlenslets and light emitters.

A set of o-pixels may be turned off along the cluster's peripheries.

The panel may be transmissive and further comprises a backlight to illuminate the panel, wherein the backlight comprises a plurality of microlenslets and light emitters; the state of a light emitter may change between active and inactive in time intervals;
wherein at a given instant a fraction of the light emitters are inactive wherein the emitters are in an off state;
wherein each channel further comprises a plurality of microlenslets and active light emitter pairs;
wherein the object pixels of the cluster are grouped in microclusters, each one associated to a corresponding microlenslet of the channel;
wherein the assignation of microlenslets and active light emitter to channels may change in time intervals; and
wherein each active light emitter illuminates the channel's lenslet output pupil through its corresponding microlenslet and the lenslet, producing an image of the light emitter on the output pupil of the lenslet.

The images of a light emitter through two adjacent microlenslets may be formed on the output pupil of two non-adjacent lenslets whose centers are separated by a distance at least twice the minimum diameter of the output pupil of the lenslets.

Adjacent light emitters may produce different primary colors.

Optionally, the light emitters are light emitting diodes.

Preferably some active light emitters are dimmed according to the brightness of the image to be displayed on the microcluster associated to the emitter.

At least one microcluster may contain an object pixel with a transmission greater than 90% of its maximum transmission.

The light emitters many be pixels of a second transmissive panel back illuminated by a lightguide. The lightguide may be fed sequentially by different primary colors.

Each light emitter may comprise a collimator.

The lenslets may be configured in a locally-squared array.

The lenslets may be configured in a locally-hexagonal array.

The fraction of active emitters may be less than 50%.

The number of microlenslets belonging to a channel may be greater than 20.

The optical system may further comprise at least a conforming lens along the ray path from the panel to the eye. The conforming lens may be a pancake optical configuration.

There nay be more green color ray pencils than blue color ray pencils.

The intersection of each ray pencil with the eye pupil plane may fully lays inside the eye pupil.

The intersection of each ray pencil with the eye pupil plane may fully lay inside a static eye pupil position.

The display device may further comprise a driver operative to drive and assign the object pixels to the channel clusters.

The display device may further comprise a pupil tracker and a driver operative to dynamically drive and assign the object pixels to the channel clusters.

The display device in any of the embodiments may further comprise a pupil tracker and a driver operative to dynamically drive and assign the object pixels and light emitters to the channel clusters.

The conforming lens may have at least one surface with slope discontinuities.

The display device may include two or more panels per eye.

The display device may further comprise a second display device, a mount to position the first and second display devices relative to one another such that their respective lenslets project the light towards two eyes of a human being, and a driver operative to cause the display devices to display objects such that the two virtual images from the two display devices combine to form a single image when viewed by a human observer.

In an embodiment, the object pixels close to a border of the cluster are dark.

The display driver may drive more power to the object pixels whose corresponding pencils enter partially the eye pupil to compensate for flux lost by vignetting.

The display device may further comprise a mask to block the undesired light from the lenslet exit apertures.

The foregoing and other features of the invention and advantages of the present invention will become more apparent in light of the following detailed description of the preferred embodiments, as illustrated in the accompanying figures. As will be realized, the invention is capable of modifications in various respects, all without departing from the invention. Accordingly, the drawings and the description are to be regarded as illustrative in nature, and not as restrictive.

### BRIEF DESCRIPTION OF DRAWINGS

The above and other aspects, features and advantages of the present invention will be apparent from the following more particular description thereof, presented in conjunction with the following drawings wherein:

FIG. 1 shows a lenslet array between an eye and a panel display.

FIG. 2 shows a configuration based on that in FIG. 1 but where the display panel has adaptable emission angles.

FIG. 3 shows an embodiment similar to that in FIG. 2, but now illustrating the inner structure of the display.

FIG. 4 shows a situation in which the eye pupil has rotated relative to the position in FIG. 3.

FIG. 5 shows a possible the inner structure of the panel in FIG. 1.

FIG. 6 shows cluster and lenslet receiving light from emitters trough microlenslets.

FIG. 7 shows another view of the same configuration as FIG. 6

FIG. 8 shows the same embodiment of FIG. 6 but where the eye pupil has rotated relative to the position in FIG. 6.

FIG. 9 shows an embodiment similar to that in FIG. 6 but with microlenslets of shorter focal distance and emitters of smaller size.

FIG. 10 shows an embodiment similar to that in FIG. 9 but with microlenslets of shorter focal distance and emitters of smaller size.

FIG. 11 shows a configuration similar to that in FIG. 6 and FIG. 7 but now incorporating additional a conforming lens.

FIG. 12 shows a locally-hexagonal array of lenslets with pancake configuration.

### DETAILED DESCRIPTION

A better understanding of the features and advantages of the present invention will be obtained by reference to the following detailed description of the invention and accompanying drawings, which set forth illustrative embodiments in which the principles of the invention are utilized.

The embodiments in the present invention consist on an display device comprising one or more displays per eye, operable to generate a real image comprising a plurality of object pixels (or opixels for short); and an optical system, comprising a plurality of lenslets, each one having associated at a given instant a cluster of object pixels. Each lenslet produces a ray pencil from an object pixel of its corresponding cluster. We shall call ray pencil (or just pencil) to the set of straight lines that contain segments coincident with ray trajectories illuminating the eye, such that these rays carry the same information at any instant. The same information means the same (or similar) luminance, color and any other variable that modulates the light and can be detected by the human eye. In general, the color of the rays of the pencil is constant with time while the luminance changes with time. This luminance and color are a property of the pencil. The pencil must intersect the pupil range to be viewable at some of the allowable positions of the pupil. When the light of a pencil is the only one entering the eye's pupil, the eye accommodates at a point near the location of the pencil's waist if it is being gazed and if the waist is far enough from the eye. The rays of a pencil are represented, in general, by a simply connected region of the phase space. The set of straight lines forming the pencil usually has a small angular dispersion and a small spatial dispersion at its waist. A straight line determined by a point of the central region of the pencil's phase space representation at the waist is usually chosen as representative of the pencil. This straight line is called central ray of the pencil. The waist of a pencil may be substantially smaller than 1 mm² and its maximum angular divergence may be below ±10 mrad, a combination which may be close to the diffraction limit. The pencils intercept the eye sphere inside the pupil range in a well-designed system. The light of a single o-pixel lights up several pencils of different lenslets, in general, but only one or none of these pencils may reach the eye's retina, otherwise there is undesirable cross-talk between lenslets. The o-pixel to lenslet cluster assignation may be dynamic because it may depend on the eye pupil position.

The waist of a pencil is the minimum RMS region of a plane intersecting all the rays of the pencil. This flat region is in general normal to the pencil's central ray. In some embodiments the waists of some or all of the pencils can be grouped by its proximity to certain surfaces. These surfaces are called waist surfaces. Sometimes planes can approximate these surfaces. These planes are preferably normal to the frontward direction.

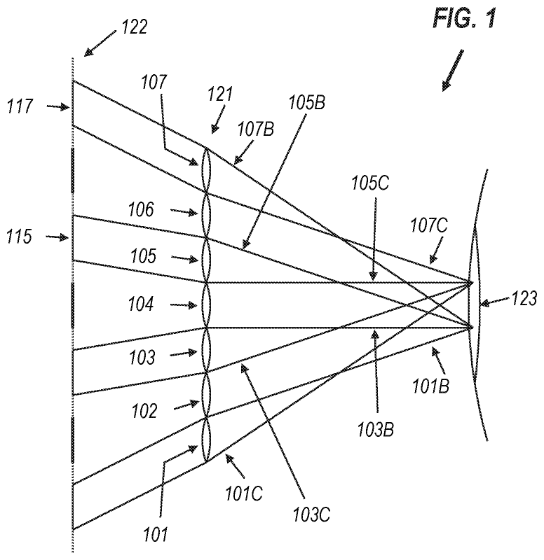

FIG. 1 shows a lenslet array 121 facing a display panel 122. Also shown are rays 107B and 107C starting at the edges of cluster 117 and crossing the edges of lenslet 107. Said lenslet 107 generates fields whose directions are contained between those of rays 107B and 107C as they cross eye pupil 123. Rays 105B and 105C starting at the edges of cluster 115 cross the edges of lenslet 105. Said lens 105 generates fields whose directions are contained between those of rays 105B and 105C as they cross eye pupil 123. Rays 107C and 105B are parallel so the directions of the fields through lenslets 107 and 105 fill all directions between those of rays 107B and 105C as they cross eye pupil 123. Accordingly, lenslet 103 generates fields whose directions are contained between those of rays 103B and 103C as they cross eye pupil 123. Also, lenslet 101 generates fields whose directions are contained between those of rays 101B and 101C as they cross eye pupil 123. Rays 105C and 103B are parallel and so are rays 103C and 101B. The family of lenslets 101, 103, 105 and 107 generates fields in all directions between those of rays 101C and 107B. The other family of lenslets 102, 104, 106 works in a similar way and also generates a set of partial virtual images which together form a continuous full virtual image visible through pupil 123. The two full virtual images of said two families of lenses overlap. Said two full virtual images may be interlaced to increase the perceived resolution of the embodiment.

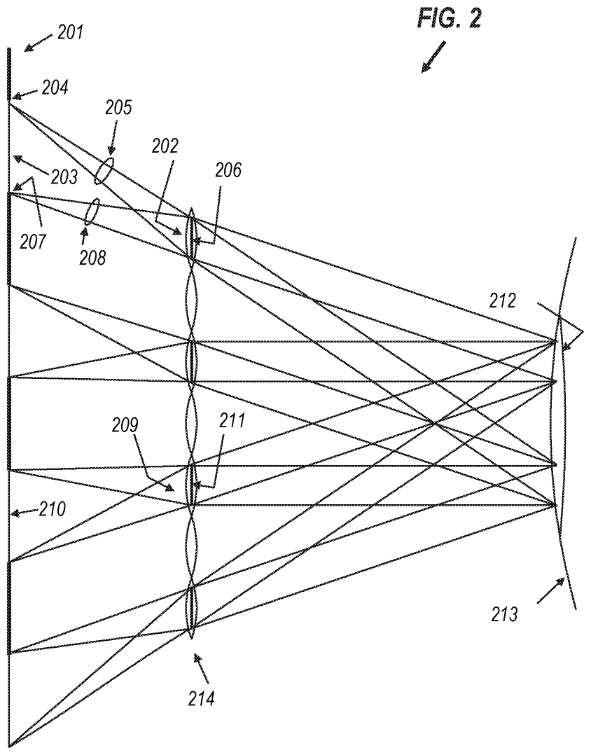

FIG. 2 shows a configuration based on that in FIG. 1 but where display panel 122 is replaced by a different panel 201 with adaptable emission angles. Lenslet 202 has cluster 203 that now emits light within said emission angles. In particular, edge 204 of cluster 203 emits light in cone 205 that crosses lenslet 202 inside segment 206 which almost occupies all the lenslet 202 aperture. Accordingly, edge 207 of cluster 203 emits light in cone 208 that crosses lenslet 202 inside segment 206. In general, any point in cluster 203 emits light in a cone that crosses lenslet 202 inside segment 206.

Different lenslets and their clusters have a similar behavior. As another example, light emitted from the points of cluster 210 cross the corresponding lens 209 and segment 211. Light crossing all lenslets or array 214 will enter the eye pupil 212 making it visible to the eye 213.

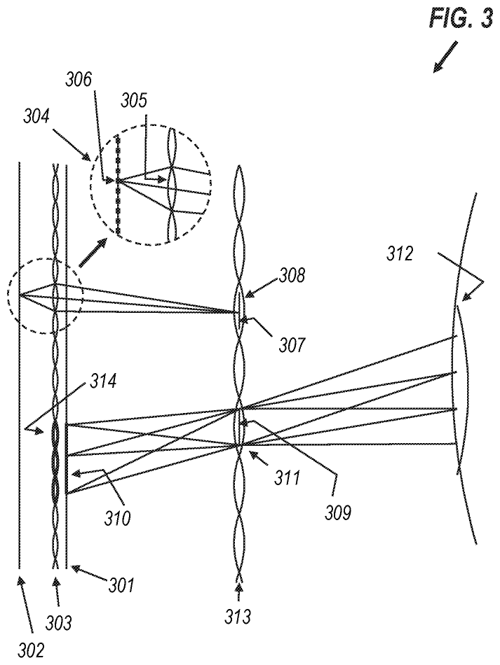

FIG. 3 shows an embodiment similar to that in FIG. 2, but now illustrating the inner structure of the display. It is composed of a transmissive panel (e.g. an LCD) 301 that is backlit by an emitting panel 302 coupled to an array of microlenslets 303. A detail of said component is shown in greater detail in inset 304. Microlenslet 305 images emitter 306 onto segment 307 inside lenslet 308 aperture or close to it. Emitter 306 is on, but its neighboring emitters are off and do not emit light. Accordingly, each microlenslet of set 314 (with bold lines) creates an overlapping image 309 of one emitter of emitting panel 302. Said set 314 of microlenslets illuminates region 310 of the LCD panel constituting the cluster associated to the lenslet 311. The light from cluster 310 is redirected by lenslet 311 of array 313 to the eye pupil 312.

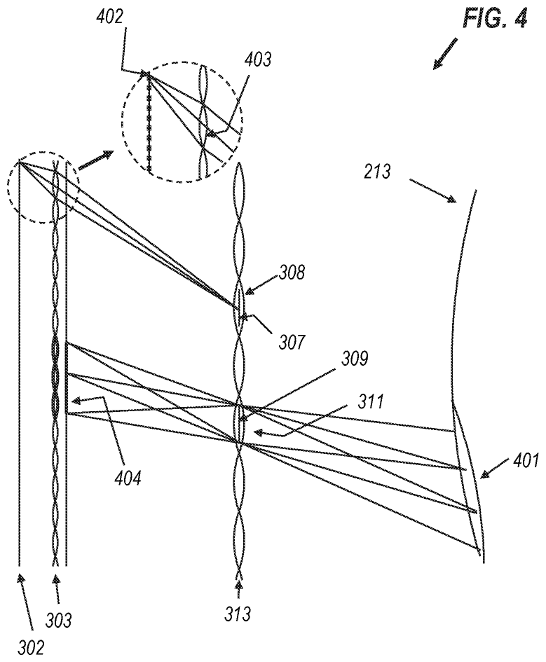

FIG. 4 shows a situation in which the eye pupil rotates to position 401. Now emitter 306 (FIG. 3) is turned off and emitter 402 is turned on. Microlenslet 403 images emitter 402 onto the same segment 307 inside lens 308. The microlenses of array 303 close to cluster 404 of lenslet 311 form images of corresponding emitters of emitting panel 302 onto segment 309 through lenslet 311. Light crossing all lenslets or array 313 will enter the rotated eye pupil 401 making it visible to the eye 213.

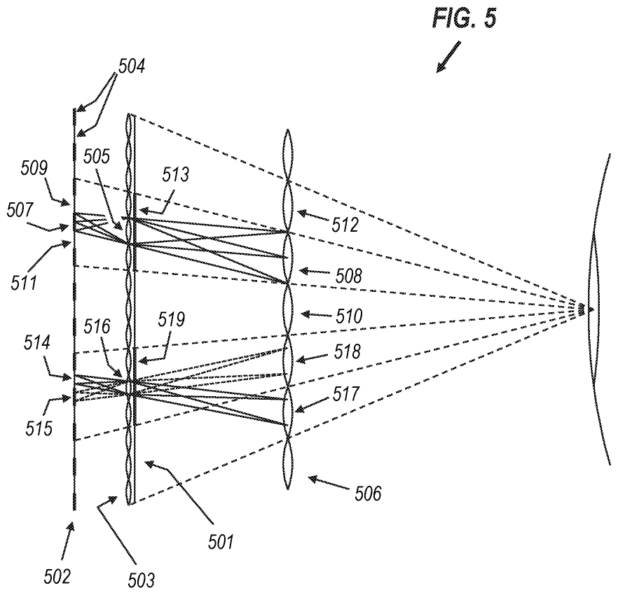

FIG. 5 shows an embodiment similar to that in FIG. 1, but now illustrating a possible the inner structure of the display panel. It is composed of an LCD panel element 501 that is backlit by an emitting panel 502 coupled to an array of microlenslets 503. Said emitting panel 502 is composed of an array of emitters 504. Also shown in an array of lenslets 506. Microlenslet 505 images emitter 507 into lenslet 508 aperture. Said microlenslet 505 also images emitter 509 into lenslet 510 and emitter 511 into lenslet 512. Similarly, microlens 516 images emitter 514 to lenslet 517 and emitter 515 to lenslet 518 trough cluster 519 of lenslet 518.

In this configuration, if emitter 507 is on, microlenslet 505 will emit light towards lenslet 508 through LCD panel 501. However, if emitter 509 is off, lenslet 505 will not emit light towards lenslet 510 through LCD panel 501 and no crosstalk is generated. Accordingly, if emitter 511 is off, microlenslet 505 will not emit light towards lenslet 512 through LCD panel 501 and no crosstalk is generated.

Using this embodiment, it is then possible to turn on a given emitter in panel 502 such that a given microlenslet in panel 503 will illuminate a given lenslet in array 506. However, by turning off the emitters next to said emitter in panel 502, said microlenslet will not emit light to the neighbors of said lenslet, avoiding crosstalk.

A given lenslet 508 is associated with a cluster 513 because both belong to the same channel. One may then select the microlenslets under said cluster and turn on only the emitters such that said microlenslets illuminate lenslet 508.

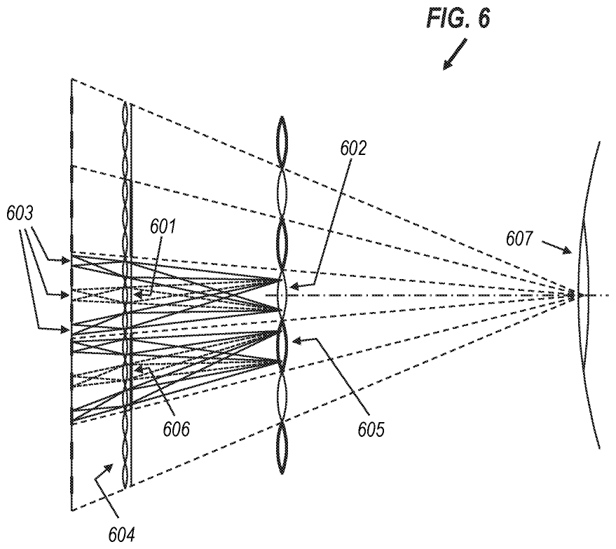

FIG. 6 shows cluster 601 of lenslet 602, which is illuminated by light from emitters 603 trough microlenslets of array 604. Light crossing cluster 601 also crosses lenslet 602. Accordingly, lenslet 605 is illuminated by light crossing its corresponding cluster 606.

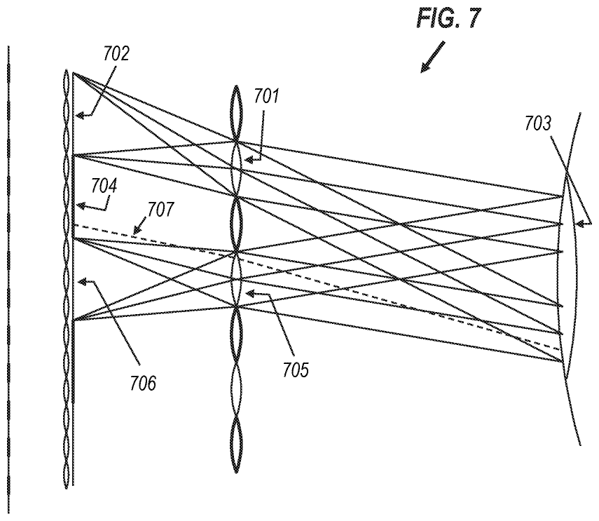

FIG. 7 shows the same configuration as FIG. 6. Each lenslet forms a virtual image of its cluster that is visible to the eye. This is the case, for example, of lenslet 701 that forms a virtual image of its cluster 702 that is visible to the eye 703. Lenslet 701 receives light only from its cluster 702 and not from neighboring cluster 704, as per the configuration disclosed in FIG. 6. Accordingly, lenslet 705 receives light only from its cluster 706 and not from neighboring cluster 704. Crosstalk ray 707 is therefore not possible.

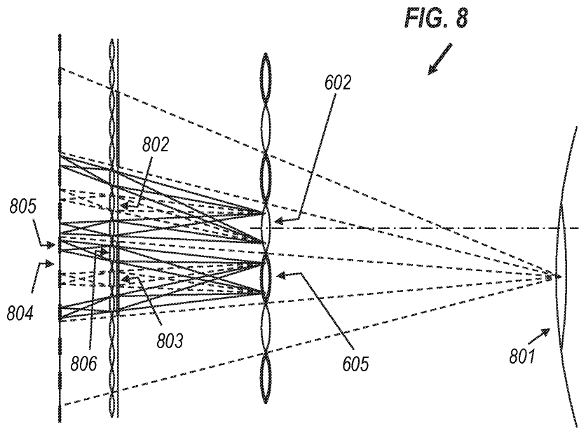

FIG. 8 shows the same embodiment of FIG. 6 but where the eye pupil moved from position 607 to position 801. The clusters of lenslets 602 and 605 have also moved to positions 802 and 803 to track the movement of the eye pupil. In the configuration of FIG. 6, microlenslet 806 was under the cluster of lenslet 602. Emitter 804 that was on and microlenslet 806 redirected its light to lenslet 602. In this new configuration microlenslet 806 is under the cluster of lenslet 605. Emitter 804 is now off and emitter 805 is now turned on. Microlenslet 806 now redirected the light from emitter 805 to lenslet 605.

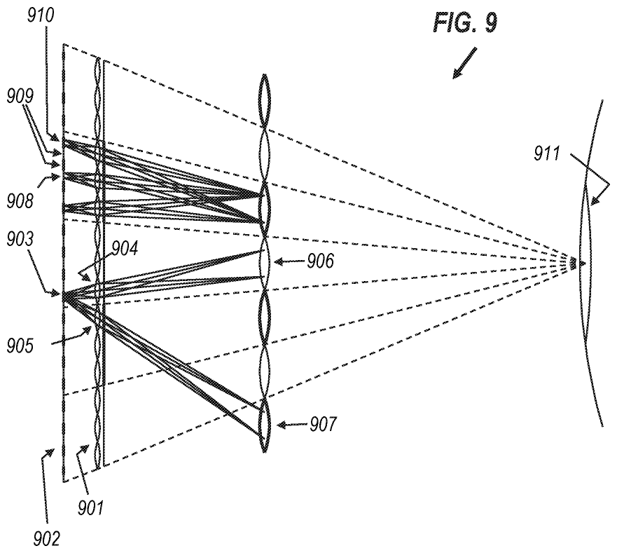

FIG. 9 shows an embodiment similar to that in FIG. 6 but in which the microlenslets 901 have a shorter focal distance and emitters 902 are of a smaller size. Now, light from an emitter 903 is redirected by two consecutive microlenses 904 and 905 to two lenslets 906 and 907 that are far from each other. This alleviates the crosstalk condition. Note that, the light coming from microlenslet 905 and reaching lenslet 907 is easily redirected out of the eye pupil 911, thus avoiding the crosstalk condition. Also note that, in between two emitters 908 and 910 that are on, there are two emitters 909 that are off.

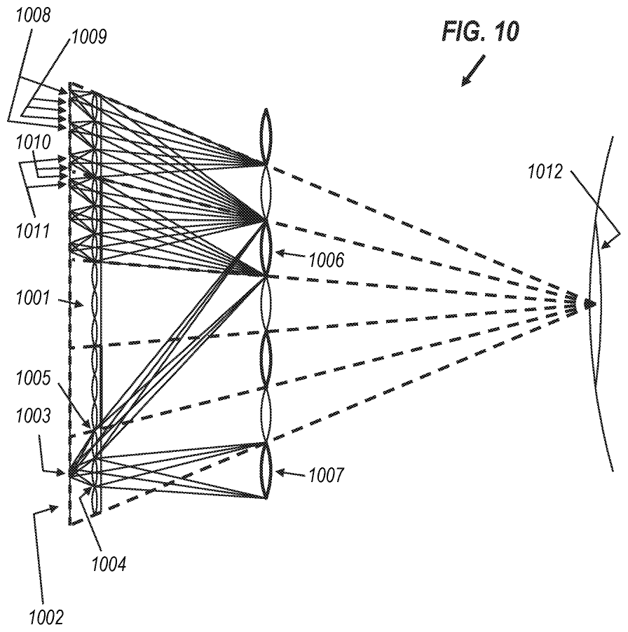

FIG. 10 shows an embodiment similar to that in FIG. 9 but in which the microlenslets 1001 have a shorter focal distance and emitters 1002 are of a smaller size. Light from an emitter 1003 is redirected by two consecutive microlenses 1004 and 1005 to two lenslets 1006 and 1007 that are far from each other. This alleviates even further the crosstalk condition. Note that, the light coming from microlenslet 1005 and reaching lenslet 1006 is easily redirected out of the eye pupil 1012, thus avoiding the crosstalk condition. Also note that, in between two emitters 1008 that are on, there are three emitters 1009 that are off. At the edge of the clusters, in between two emitters 1011 that are on, there are two emitters 1010 that are off.

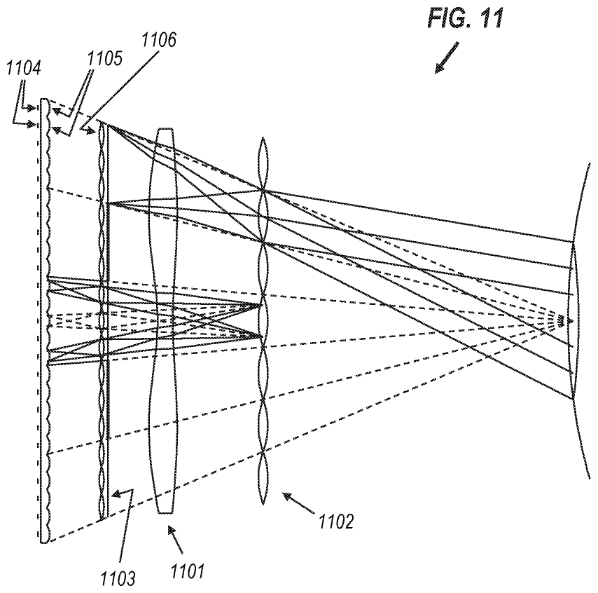

FIG. 11 shows a configuration similar to that in FIG. 6 and FIG. 7 but now incorporating additional a conforming lens element 1101 (also called peanut lens) between the array of minilenses 1102 and the LCD panel 1103. Said peanut lens will allow the system to produce a variable magnification with higher resolution at the center of the field of view and lower resolution at its periphery.

Also shown are light emitters 1104 coupled to nonimaging collimators 1105. Said nonimaging collimators widen the apparent size of said light emitters as seen from the microlens array 1106. Example of such collimators may be Compound Parabolic Concentrators (CPCs) or aspheric lenses.

Without loss of generality consider next the case in which the interlacing factor k=2 will have 4 families of lenslets interlaced and with a square subpixel panel configuration. (which could be Red, Green, Blue and White if the white light emitter is more efficient than the Green, or alternatively Red, Green, Blue and Yellow is a wider color gamut is desired). Any skill in the art can be extrapolate this description to other interlacing factors, as k=2^{1/2}, 3^{1/2}, 7^{1/2}, 3, etc. As described in PCT11, a squarish lenslet array configuration is the suitable one for this interlacing k=2 factor, so four families on lenslets, each one producing the full virtual image, but their pixels being projected to the eye interlaced. “Squarish” or stands for a general case in which the lenslets distribution is not perfectly allocated in a square grid, but is locally squared, either because the channel designs are done to produce variable cluster sizes, or because one or more conforming lenses are used in the system.

Consider the canonical simplification to illustrate the invention in which a square array of lenslets is used, whose pitch is d, located at a distance to the eye pupil ER (which stands for eye relief) and that when the eye rotates the pupil approximately shifts laterally, perpendicular to the z axis. To avoid the resolution of the virtual image be limited by diffraction, the size of the lenslet output pupils should be larger than, let say, 0.75 mm, so the lenslets pitch d, will not be smaller that that value. A minimum design value should be around d=0.8 mm, since for λ=589.3 nm, the Rayleigh criterion states that the resolvable pixel will be 0.61λ/d=0.045 mrad=0.0257 deg, that is, 1/0.0257≈40 ppd.

An underfilling strategy with k=2 requires that each minilens produces a virtual image with size in its diagonal cross section given by:

$$tan {α}_{n + 1} - tan {α}_{n} = \frac{\sqrt{2} d}{ER} \qquad [ Equation 1 ]$$

where αₙ₊₁ and αₙ are the extreme diagonal fields of channel n, and are the conjugates of the diagonal corners of the clusters. Assuming the waist plane is for simplicity of this explanation is located at infinity and a tangent law mapping in this example, we get that:

$$tan {α}_{n + 1} - tan {α}_{n} = \frac{\sqrt{2} c}{F} \qquad [ Equation 2 ]$$

where F is the lenslets focal length and c is the cluster side. The clusters associated to each lenslet are preferably assigned so their size is proportional to the solid angle subtended by their output pupil from the center of the eye pupil. In this canonical example, with the clusters are squares with side:

$$c = d \frac{S + F}{F} \qquad [ Equation 3 ]$$

Combining Equations 1, 2 and 3, we can solve for F and c to find:

F=ER [Equation 4]

c=2d=1.6 mm [Equation 5]

Notice this focal length is very long compared to the underfilling strategy disclosed in PCI 11, in which the illumination is not confined in the channels, since the equivalent canonical example in that case gets:

$$F = \frac{2}{1 + 3 \sqrt{2}} ER = 0.38 ER \qquad [ Equation 6 ]$$

If the comparison between both systems is done with the same eye relief ER and the same circular FOV=90 deg, the present invention requires the use of a larger display due to the larger focal length of the lenslets. As an example, for ER=15 mm, the present invention (in this canonical example) has F=15 mm and requires a 3.34 inch diagonal panel, while PCT1.1 invention has F=5.72 mm and uses a 2.31 inch diagonal panel. If both panel have the same total pixel count of 4.5 k×4.5 k, the former opixel pitch will be 13.33 microns, while the latter has 9.21 microns. Since the resolution at the virtual image is given by:

$$Resolution ( ppd ) = k \frac{π}{180} \frac{F}{op} \qquad [ Equation 7 ]$$

where op is the panel opixel pitch, the present invention (in this canonical example) will provide a resolution of 39.3 ppd (matching the diffraction limit above), while PCT11 invention obtains only 21.7 ppd, that is, nearly a half.

If the comparison is done, instead of with the same ER, with the same panel with 3.34 inch diagonal and the same circular FOV=90 deg FOV, then the PCT11 invention with have an ER=21.7 mm, F=8.28 mm, but will provide a very similar resolution (22.3 ppd).

The union of all ray pencil prints UPP of the channels at the pupil plane is equal for all channels and is the same for the canonical example of this invention and the equivalent canonical examples of the PCT11 invention. It is given by a square of diagonal centered on the eye pupil:

UPP diagonal<3d\sqrt{2} [Equation 8]

Therefore, for no vignetting to be produced by the eye pupil, the minimum size D of the user eye pupil should be bigger than that UPP. For d=0.8 mm, D≥3.4 mm (for smaller pupil, some vignetting occurs, that can be corrected by software).

Regarding the backlight design, it is formed by microlenslets imaging the plane where an array of light emitters is placed on the output pupil of the lenslets. This type of illumination is known as Köhler integration. Each light emitters position is configured together with the microlenslets and lenslets positions, so the following conditions are fulfilled:
Condition 1. For any lenslet and any microlenslet that belongs to the lenslet channel, there is a light emitter that may illuminate the lenslet output pupil, the microlenslet producing an image of the light emitter on the output pupil of one lenslet and laying inside it, preferably filling it, and not invading the adjacent ones.
Condition 2. The images of a light emitter through two adjacent microlenslets is formed on two non-adjacent lenslets whose centers are separated by a distance preferably at least three times the lenslet pitch.

At a given instant, a microlenslet is associated to a single channel and a single light emitter is associated to that microlenslet, and it will be addressed to illuminate its associated channel lenslet through the microlenslet (eventually this addressing may be such that no flux is produced if local dimming is being used). Due to Condition 2, the adjacent lenslets will not be illuminated by this microlenslet, typically two or more coronas of lenslets around the associated one. At another instant, the microlens may become associated to a different channel, and according to Condition 1, this can be done by activating a different light emitter to be associated to said microlenslet to illuminate the lenslet associated to that different channel.

In a preferred embodiment, the light emitters are all white and the panel is LCD type with color filters on each opixel. Such white emitters may be generated by a second, lower resolution LCD without color filters whose pixels become the emitters when they allow polarized light to cross through. This light is preferably generated by several R, G, and B LEDs that feed a lightguide whose purpose is to spread evenly the light through the LCD as in a conventional LCD display.

In a different embodiment the color filter may be allocated on the minilenses instead of being on the panel o-pixels. Then, all the pencils of each channel will have the same color. This means that the different families of minilenses will generate the whole image, but of different colors, and their superposion generates the final image.

In another preferred embodiment, the light emitters themselves emit a primary color, and again each family of channels of the interlacing is associated to one color. In this embodiment no color filters are used, resulting in a higher efficiency configuration. In the previous canonical example, a k=2 design in square configuration will have 4 families of lenslets interlaced, and each one can be associated to one of the four colors R, G, B, W. If this embodiment, one lenslet belongs to a given family, it will have a fixed colour too, and in this case a lenslet family can be named by its color. Assume the previous canonical example in a square grid where square clusters contain N×N microlenslets. The light emitters array will be in a four color square grid analogous to the one of the lenslets, so along a line there will be light emitters of two colors, for instance . . . RGRGRG . . . while along a contiguous line will be the other two colors . . . BWBWBW . . . . If a microlenslet belong, for instants, a red channel, its corresponding active light emitter will be red, and so will the active light emitter of an adjacent microlenslet of the same cluster be.

Let M−1 be the number of light emitters which are inactive between those two. According to Condition 2, M is preferable greater than 3. Therefore, if we denote with lower case the inactive light emitters and upper case the active ones, we could have M=4 which will mean that, for instance in red cluster we would have . . . RgrgRgrgR . . . and . . . bwbwbw . . . . In the adjacent green cluster the active pixels will be . . . rGrgrGrgr . . . and . . . bwbwbw . . . . In the transition between these red and green clusters we will preferably have . . . RgrgRgrGrgrG . . . M could also be another greater even number (for instance, 6), but the larger M the smaller size of light emitters is needed.

Following FIG. 9, the microlenslets pitch p_{μ}, their focal length f, distance S to the lenslets, the lenslets pitch d, the focal length of the lenslets F and the light emitters pitch p_{LE} are related in the Gaussian optics approximation by:

$$\frac{F}{d} = \frac{S}{{p}_{LE}} \frac{F + S}{M {p}_{LE}} \frac{ER}{d} = \frac{ER + F + S}{( MN - 2 ) {p}_{LE}} \frac{1}{F} + \frac{1}{S} = \frac{1}{f} \qquad [ Equation 9 ]$$

Using that F=ER (Eq. 4), we can solve Eq. 9 to get:

$${p}_{μ} = \frac{2 d}{N} {P}_{LE} = \frac{{p}_{μ}}{M - \frac{2}{N}} S = \frac{2 ER}{MN - 2} f = \frac{ER S}{ER + S} \qquad [ Equation 10 ]$$

For d=0.8 mm, ER=15 mm, N=10 and M=4, we get p_{μ}=160 microns, p_{LE}=42.1 microns, S=790 microns and f=750 microns.

The light from each active light emitter associated to a channel will reach the eye pupil through lenslets of other channels outside a circle on the eye pupil plane concentric with the eye whose diameter fulfills:

$$\frac{\frac{{D}_{max}}{2} + \frac{d}{2}}{ER} = \frac{M - \frac{1}{2} c - {p}_{μ}}{F} \qquad [ Equation 11 ]$$

Using again that F=ER (Eq. 4) and that c=2d (Eq. 5), we obtain:

Dₘₐₓ=(4M−3)d−2p_{μ} [Equation 12]

That is, Dₘₐₓ=10.8 mm, which is much larger than the maximum eye pupil diameter of the users that is expected for in operation (5-7 mm).

The calculation done so far is valid for any position of the eye pupil perpendicular to the z axis, provided that there is an eye pupil tracker and a panel driver that drives the panel opixels and light emitters to modify the clusters accordingly. If the center of the eye pupil shifts, the centers of the clusters should shift by the same amount on the panel plane in this canonical example, because the F=ER (Eq. 4). The shift of cluster centers is discretized to the values p_{μ}, since they are composed by N×N microlenslets. This implies that the print diagonal of Eq. 8 should be enlarged in practice by 2\sqrt{2}p_{μ} (which is 0.45 mm in this example). Nevertheless, if the lenslet design includes dark corridors (set of o-pixels turned off along the cluster's peripheries), the shift of cluster centers is discretized to the values op, i.e., the o-pixel pitch, so the enlargement of the UPP diagonal is negligible.

Another preferred embodiment is the hexagonal configuration, which is suitable for panels with hexagonal pixel structures (called RGB-delta type) interlacing factors k=3^{1/2} and k=7^{1/2}. This configuration produces a UPP on the pupil plane which is closer to a circle, better fitting the eye pupil shape. In the k=3^{1/2} case, the cluster contours are preferable arranged with a. 90 deg rotation with respect to the lenslet contours, to produce the tiling of the partial virtual images. The hexagonal contour of the clusters can be properly defined with the panel o-pixels.

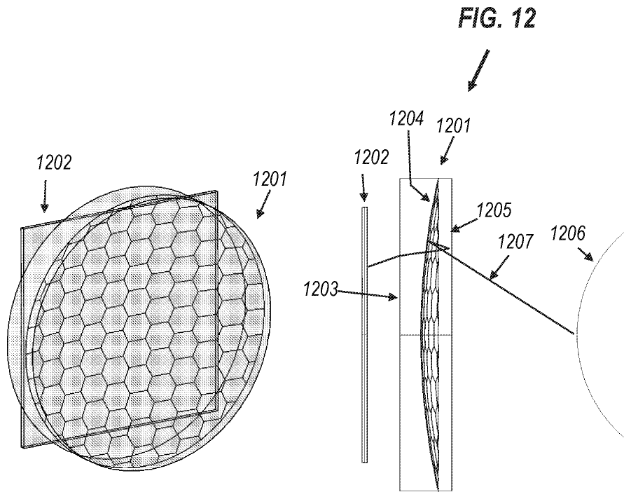

FIG. 12 shows a locally-hexagonal array of lenslets with pancake configuration 1201, compose of two solid dielectric pieces glued together and facing a display 1202, which emits circularly polarized light. The light from the panel refracts on surface 1203, which is in general freeform, but preferable aspheric, and propagates across the semi-transparent mirror surface 1204 towards surface 1205, where is finds a stack of a quarter wave plate and a reflective polarizer (an absorbing polarizer can be added too) that reflect the design light back towards surface 1204 keeping the same original circular polarization. On that semi-transparent mirror, light gets reflected changing its circular polarization orientation so it gets transmitted through 1205 towards the eye 1206, as illustrated by ray 1207. Surface 1205 is preferably flat or cylindrical so films can be laminated without stress, but aspheric or freeform profiles are also doable by coinjection of the films.

By combining the present invention with the inventions disclosed in PCT2 and PCT8 a further increase in resolution and/or field view can be achieved if the switching time of the panel allows a time multiplexing scheme.

Moreover, color sequential techniques can also be applied to the present invention. For example, the light emitters can be made of an LCD arrangement such that the LCD pixels become the emitters when they allow polarized light to cross through. This light is generated by several R, G, and B LEDs, which feed a lightguide whose purpose is to spread evenly the light through the LCD as in a conventional LCD display. The color sequential scheme is achieved by sequentially switching the R, G and B LEDs feeding the light guide. Note that in this case, at any instant all the openings and consequently all the channels and all the pencils are fed with the same light color. This is important for the interlacing design (see Definitions above) because now two pencils forming the same accommodation pixel have the same color and consequently the eye only perceives an added brightness for this accommodation pixel but not a color combination. In this situation, interlacing can still improve the resolution if the panel fill factor is low enough (ideally 25% or less) so there are opaque regions of areas similar or greater than the lit ones.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening.

The recitation of ranges of values herein are merely intended to serve as a shorthand method of referring individually to each separate value falling within the range, unless otherwise indicated herein, and each separate value is incorporated into the specification as if it were individually recited herein.

All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not impose a limitation on the scope of the invention unless otherwise claimed. The various embodiments and elements can be interchanged or combined in any suitable manner as necessary.

The use of directions, such as forward, rearward, top and bottom, upper and lower are with reference to the embodiments shown in the drawings and, thus, should not be taken as restrictive. Reversing or flipping the embodiments in the drawings would, of course, result in consistent reversal or flipping of the terminology.

No language in the specification should be construed as indicating any non-claimed element as essential to the practice of the invention.

It will be apparent to those skilled in the art that various modifications and variations can be made to the present invention without departing from the spirit and scope of the invention. There is no intention to limit the invention to the specific form or forms disclosed, but on the contrary, the intention is to cover all modifications, alternative constructions, and equivalents falling within the spirit and scope of the invention, as defined in the appended claims. Thus, it is intended that the present invention cover the modifications and variations of this invention provided they come within the scope of the appended claims and their equivalent.

1. A display device comprising:
a panel, operable to generate a real image comprising a plurality of object pixels; and an optical system, comprising a plurality of lenslets; the panel and the optical system both arranged in a plurality of channels, each channel comprising a lenslet and a cluster of object pixels;
wherein the assignation of object pixels to clusters may change in time intervals;
wherein each object pixel of a cluster projects a corresponding ray pencil from the channel lenslet towards an imaginary sphere at an eye position; said sphere being an approximation of the eyeball sphere and being in a fixed location relative to a user's skull;
wherein said ray pencils of each channel are configured to generate a partial virtual image from a real image of its corresponding cluster, and wherein the partial virtual images of the channels combine to form a virtual image to be visualized through a pupil of an eye during use; and
wherein the average illuminance produced by each cluster on the output pupil of the lenslet associated to this cluster is at least 10 times greater than the average illuminance generated by this cluster on the output pupil of at least one of any other lenslet.

2. A display device of claim 1, wherein the average illuminance produced by at least one cluster on the output pupil of the lenslet associated to this cluster is at least 10 times greater than the average illuminance generated by this cluster on the output pupil of a set of lenslets surrounding the lenslet associated to that cluster.

3. A display device of claim 2, wherein said set of lenslets include the lenslets adjacent to the lenslet associated to the cluster.

4. A display device of claim 1, wherein at least two of the lenslets cannot be made to coincide by a simple translation rigid motion.

5. A display device of claim 1, wherein adjacent lenslets project light of different primary colors.

6. A display device of claim 5, wherein the different colors are produced by color filters.

7. A display device of claim 1, wherein at least one lenslet has a pancake optical configuration.

8. A display device of claim 1, wherein waists of said pencils of adjacent lenslets are interlaced at a waist surface.

9. A display device of claim 1, wherein foveal rays are a subset of rays emanating from the lenslets during use that reach the eye and whose straight prolongation is away from the imaginary sphere center a distance smaller than a value between 2 and 4 mm; and
wherein the image quality of the virtual image formed by the foveal rays is greater than the image quality of the virtual image formed by non-foveal rays emanating from the lenslets during use.

10. A display device of claim 1, wherein each lenslet produces a ray pencil from each object pixel of its corresponding cluster, said pencils having corresponding waists laying close to a waist surface.

11. A display device of claim 1, wherein the ray pencils are activated to make the accommodation pixels lay close to a waist surface.

12. A display device of claim 1, further comprising a backlight to illuminate the panel.

13. A display device of claim 1, further comprising a backlight to illuminate the panel, wherein the backlight comprises a plurality of microlenslets and light emitters.

14. A display device of claim 1, wherein a set of o-pixels is turned off along the cluster's peripheries.

15. A display device of claim 1, wherein the panel is transmissive and it further comprises a backlight to illuminate the panel, wherein the backlight comprises a plurality of microlenslets and light emitters;
wherein the state of a light emitter may change between active and inactive in time intervals;
wherein at a given instant a fraction of the light emitters are inactive wherein the emitters are in an off state;
wherein each channel further comprises a plurality of microlenslets and active light emitter pairs;
wherein the object pixels of the cluster are grouped in microclusters, each one associated to a corresponding microlenslet of the channel;
wherein the assignation of microlenslets and active light emitter to channels may change in time intervals; and
wherein each active light emitter illuminates the channel's lenslet output pupil through its corresponding microlenslet and the lenslet, producing an image of the light emitter on the output pupil of the lenslet.

16. A display device of claim 15, wherein the images of a light emitter through two adjacent microlenslets is formed on the output pupil of two non-adjacent lenslets whose centers are separated by a distance at least twice the minimum diameter of the output pupil of the lenslets.

17. A display device of claim 15, wherein adjacent light emitters produce different primary colors.

18. A display device of claim 15, wherein the light emitters are light emitting diodes.

19. A display device of claim 15, wherein some active light emitters are dimmed according to the brightness of the image to be displayed on the microcluster associated to the emitter.

20. A display device of claim 19, wherein at least one microcluster contains an object pixel with a transmission greater than 90% of its maximum transmission.

21. A display device of claim 15, wherein the light emitters are pixels of a second transmissive panel back illuminated by a lightguide.

22. A display device of claim 21, wherein the lightguide is fed sequentially by different primary colors.

23. A display device of claim 15, wherein each light emitter further comprises a collimator.

24. A display device of claim 15, wherein the lenslets are configured in a locally-squared array.

25. A display device of claim 15, wherein the lenslets are configured in a locally-hexagonal array.

26. A display device of claim 15, wherein the fraction of active emitters is less than 50%.

27. A display device of claim 15, wherein the number of microlenslets belonging to a channel is greater than 20.

28. A display device of claim 1, wherein the optical system further comprises at least a conforming lens along the ray path from the panel to the eye.

29. A display device of claim 28, wherein the conforming lens has a pancake optical configuration.

30. A display device of claim 1, wherein there are more green color ray pencils than blue color ray pencils.

31. A display device of claim 1, wherein the intersection of each ray pencil with the eye pupil plane fully lays inside the eye pupil.

32. A display device of claim 1, wherein the intersection of each ray pencil with the eye pupil plane fully lays inside a static eye pupil position.

33. A display device of claim 1, further comprising a driver operative to drive and assign the object pixels to the channel clusters.

34. A display device of claim 1, further comprising a pupil tracker and a driver operative to dynamically drive and assign the object pixels to the channel clusters.

35. A display device of claim 15, further comprising a pupil tracker and a driver operative to dynamically drive and assign the object pixels and light emitters to the channel clusters.

36. A display device of claim 28, wherein said conforming lens has at least one surface with slope discontinuities.

37. A display device of claim 1, wherein the display device includes two or more panels per eye.

38. A display device of claim 1, further comprising a second display device, a mount to position the first and second display devices relative to one another such that their respective lenslets project the light towards two eyes of a human being, and a driver operative to cause the display devices to display objects such that the two virtual images from the two display devices combine to form a single image when viewed by a human observer.

39. A display device of claim 15, wherein the object pixels close to a border of the cluster are dark.

40. A display device of claim 33, wherein the display driver drives more power to the object pixels whose corresponding pencils enter partially the eye pupil to compensate for flux lost by vignetting.

41. A display device of claim 1, further comprising a mask to block the undesired light from the lenslet exit apertures.
